(19) United States
(12) Patent Application Publication
(10) Pub. No.: US 2024/0422638 A1
(43) Pub. Date: Dec. 19, 2024

(54) FAST SESSION TRANSFER BETWEEN WIRELESS LOCAL AREA NETWORK AND 5G NETWORK

(71) Applicant: Cisco Technology, Inc., San Jose, CA (US)

(72) Inventors: Jerome Henry, Pittsboro, NC (US); David John Zacks, Vancouver (CA); Robert Edgar Barton, Richmond (CA)

(21) Appl. No.: 18/333,658

(22) Filed: Jun. 13, 2023

(51) Int. Cl. H04W 36/14; H04W 36/30

(52) U.S. Cl. CPC H04W 36/14; H04W 36/30

(57) ABSTRACT

A method to achieve fast session transfer between radio access technologies. The method includes monitoring radio performance between an access point of a wireless local area network and a user equipment in a wireless local area network, and in response to detecting that the radio performance is below a predetermined threshold, the access point signaling the user equipment to scan for and access a cellular radio service.

### TECHNICAL FIELD

The present disclosure relates to wireless device operations, and specifically to techniques to enable fast transfer between a wireless local area network and a fifth generation (5G) network.

### BACKGROUND

In a private Long Term Evolution (LTE) 5G+wireless local area network (WLAN) (e.g., a Wi-Fi) deployment, a mobile object, such as an Internet of Things (IoT) device, can enter and exit a building. In such scenarios, there may be only marginal 5G coverage inside the building and limited Wi-Fi coverage outside the building. And, in some scenarios, a transition zone between the two wireless technologies (in terms of transition time) may be as small as less than one second. As such, there is a need to facilitate and optimize fast session transfer between a WLAN and LTE/5G (and back).

### BRIEF DESCRIPTION OF THE DRAWINGS

FIG. 1 shows a topology including a 5G radio access network and a wireless local area network (WLAN), where a WLAN controller (WLC) and/or access point (AP) hosts fast transfer logic, according to an example embodiment.

FIG. 2 shows various 5G network and WLAN coverage boundaries that are leveraged by fast transfer logic, according to an example embodiment.

FIG. 3 shows a block diagram of a WLC that hosts fast transfer logic, according to an example embodiment.

FIG. 4 shows a series of operations for effecting fast transfer between WLAN operations and 5G network operations, according to an example embodiment.

FIG. 5 shows another series of operations for executing fast transfer logic, according to an example embodiment.

FIG. 6 is a block diagram of a computing device that may be configured to execute SMF functionality including security service selection logic and perform the techniques described herein, according to an example embodiment.

### DETAILED DESCRIPTION

### Overview

A method to achieve fast session transfer between radio access technologies is presented. The method includes monitoring radio performance between an access point of a wireless local area network and a user equipment in a wireless local area network, and in response to detecting that the radio performance is below a predetermined threshold, the access point signaling the user equipment to scan for and access a cellular radio service.

In another embodiment, a device is provided. The device includes an interface configured to enable network communications, a memory, and one or more processors coupled to the interface and the memory, and configured to monitor radio performance between an access point of a wireless local area network and a user equipment in a wireless local area network in response to detecting that the radio performance is below a predetermined threshold, cause signaling, by the access point, the user equipment to scan for and access a cellular radio service.

### Example Embodiments

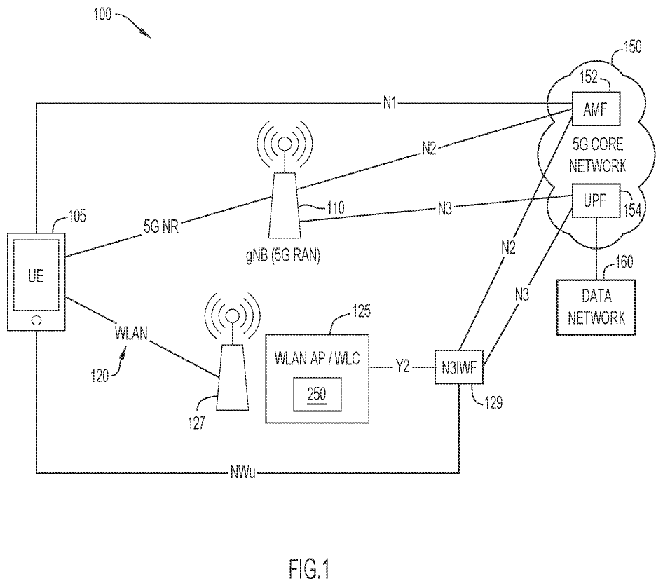

FIG. 1 shows a topology 100 including a gNB 110 of 5G cellular radio access network (RAN) and a wireless local area network (WLAN) 120, where a WLAN controller (WLC) 125 and/or access point (AP) 127 hosts fast transfer logic 250, according to an example embodiment. As shown, a UE 105 may communicate gNB 110. A 5G core network 150 may include an Access and Mobility Management Function (AMF) 152 that, e.g., supports termination of non-access stratum (NAS) signaling. NAS ciphering & integrity protection, registration management, connection management, mobility management, access authentication and authorization, and security context management.

5G core network may also include a User Plane Function (UPF) 154. UPF 154 enables connectivity to a data network 160. UPF 154 may also be configured to control packet routing and forwarding, packet inspections, QoS (Quality of Service) handling, and function as an anchor point for intra & inter radio access technology (RAT) mobility.

UE 105 may communicate with AMF 152 via an N1 link, gNB 110 may communicate with AMF 152 via an N2 link and with UPF 154 via an N3 link. Regarding WLAN 120, UE 105 may communicate with AP 127 and it, and/or WLC 125, may communicate with UPF 154 via a non-3GPP interworking function (N3IWF) 129 by way of a generic IP (Y2) untrusted link and an N3 link. UE 105 may also establish an IPSec tunnel between N3IWF 129 via an NWu link to, e.g., apply encryption for secure transport of signaling and data.

As shown, fast transfer logic 250 may be hosted by WLC 125 or AP 127.

At a high level, and as will be described more fully below, the embodiments described herein are configured to inform UE 105 of usability boundaries between WLAN 120 and the (private) 5G radio access network. A method is described to enable UE 105 to join a second RAT (e.g., 5G) upon being signaled 5G availability from the first RAT (e.g., AP 127). The method is also configured to control a gradual or progressive shift of session traffic between RATs (e.g., from WLAN 120 to the 5G radio access network) with or without scheduling, while maintaining the traffic session.

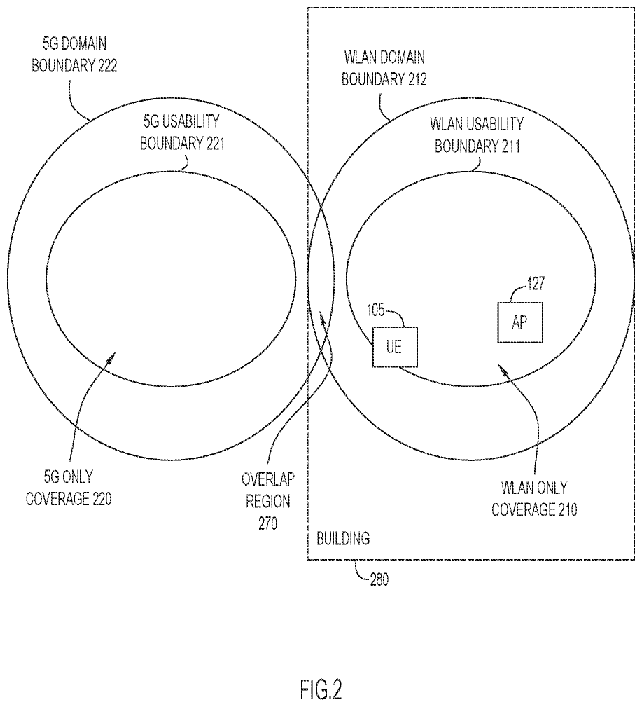

FIG. 2 shows various 5G network and WLAN coverage boundaries that are leveraged by fast transfer logic 250, according to an example embodiment. As shown, there is a WLAN only coverage region 210 defined by WLAN usability boundary 211, in which UE 105 may only communicate via WLAN 120 (i.e., there is no 5G coverage in WLAN only coverage region 210). A WLAN domain boundary 212 defines a boundary beyond which there is no longer any WLAN coverage. As also shown, WLAN coverage may be primarily available within a physical structure, such as a building 280. Also shown in FIG. 2 is 5G only coverage region 220 defined by 5G usability boundary 221, in which UE 105 may only communicate gNB 110 (i.e., there is no WLAN coverage in 5G only coverage region 220). A 5G domain boundary 222 defines a boundary beyond which there is no longer any 5G coverage.

As noted, the region, i.e., overlap region 270, where both 5G coverage and WLAN coverage are both available may be very small, and if a mobile device, i.e., UE 105 quickly moves back and forth between inside building 280 and outside building 280, an on-going communication session between UE 105 and, e.g., data network 160 may be undesirably interrupted.

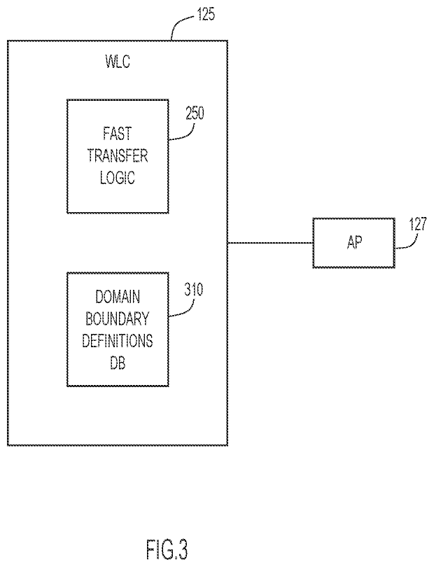

FIG. 3 shows a block diagram of WLC 125 (which could be part of AP 127) that hosts fast transfer logic 250, according to an example embodiment. In an embodiment, domain boundary definitions that define WLAN only coverage region 210, WLAN usability boundary 211, WLAN domain boundary 212, 5G only coverage region 220, 5G usability boundary 221, and 5G domain boundary 222 are recorded and stored in domain boundary definitions database 310. These several boundaries may not be predetermined, but instead indications thereof may be detected and then recorded in domain boundary definitions database 310. And, over time, the boundaries may change.

Still at a high level, fast transfer logic 250 may be configured to control session transfer from WLAN 120 to the 5G radio access network, and back, according to the following high level operations. UE 105 may associate to AP 127. UE 105 may then request traffic scheduling (FastLane+, SCS, etc.) from AP 127. WLAN 120 may establish a domain borders (e.g., WLAN usability boundary 211 and/or WLAN domain boundary 212), which could be AP-based (STA throughput/signal) or UE-based (similar KPIs, where UE 105 signals when it reaches that boundary). When UE 105 reaches a border, AP 127 signals to UE 105 to scan for and initiate a 5G session. UE 105 may then request grant free uplink access, and switches its data path to 5G.

For the return session transition, i.e., 5G to WLAN operations, UE 105 scans for AP 127, and associates, and then initiates connection to maintain single IP through AMF 152. As the WLAN 120 link becomes better than 5G, UE 105 requests traffic scheduling (FastLane+, SCS or other) from AP 127. As 5G link becomes marginal at e.g., 5G domain boundary 222, UE 105 signals to gNB and AP of the transition.

A more detailed version of the foregoing is set forth below.

### WLAN to 5G Transition

1. UE 105 associates to WLAN 120 (Wi-Fi network), and particularly to AP 127.
2. UE 105 requests traffic scheduling (e.g., FastLane+, SCS, etc.) from AP 127—at this point, UE 105 obtains differentiated service from AP 127 (i.e., AP 127 schedules traffic for UE 105, allowing UE 105 to perform with low buffer fill up, low latency and low jitter, and thus matching application flows).
3. As will be detailed below, APs including AP 127 (and gNB 110) establish 5G domain boundary 222 (i.e., a point where the 5G signal becomes available, albeit weak). When UE 105 reaches that point, AP 127 signals to UE 105 to begin scanning for 5G service.
4. APs in a deployment also establish WLAN usability boundary 211 (a point beyond which WLAN performance may falter) and WLAN domain boundary 212 (a limit of the WLAN domain). These points can be determined using various techniques. For the WLAN usability boundary, techniques may rely on the recording of previous UE traffic, and the determination of points where retries, failure, delay or jitter exceed target thresholds. For the WLAN domain boundary 212, different techniques are also available, such as AP-based embodiments, where APs exchange messages (e.g., neighbor discovery messages) and build a constellation map where the APs end up detecting which APs are surrounded by other APs (and thus not at the edge of the WLAN domain boundary 212), and which APs are at the edge (they are at the edge of the WLAN domain boundary 212). In UE-based embodiments, APs share (e.g., to each other or to WLC 125) messages heard from UE 105. When nearing an edge of a cell, UE 105 scans (sends probe requests) all channels. By sharing the UE messages, the APs (or the WLC 125) detect when a given UE is heard only by a single AP (thus concluding that it is at the edge of WLAN domain boundary 212. In another embodiment, UEs roam, and the APs (or the WLC 125) draw a traversal graph of the coverage area (i.e., a next AP for each previous AP). APs that do not have children (UE exits the WLAN domain after these APs) are WLAN domain edge APs.
5. gNBs in a deployment also establish 5G usability boundary 221 (a point beyond which 5G performances may falter) and 5G domain boundary 222 (representing a limit of the 5G domain). These points can be determined using various techniques, relying primarily on UE-gNB exchanges over the data or control channels (and measures of performances over these channels).
6. In an embodiment, UE 1-5 scans for 5G (as part of a “first walk”), or receives from gNB 110 a message signaling the 5G boundary. UE 105 relays this message to AP 127 (e.g., via an 802.11 action frame signaling). AP 127 records the WLAN signal at which the message is received. In future walks (and same or other UEs), AP 127 signals this point to UE 105, thus informing UE 105 that it is about to enter the 5G domain and should be able to attach to 5G. UE 105 scans/detects and initiates a 5G session. At this point, on the first iteration, UE 105 gets a new IP address (for the 5G link). In future iterations, and when the transition first occurred from 5G to WLAN (described below), UE 105 can ensure that a single IP address is used over the WLAN and the 5G links, even if they are not available at the same time.
7. UE 105 requests grant free uplink access. This mode allows UE 105 to send traffic to the 5G link without negotiating permission for every flow.
8. When UE 105 reaches 5G usability boundary 221. gNB 110 signals UE 105.
9. When UE 105 nears the border for WLAN usability boundary 211, AP 127 signals to UE 105. In an embodiment, this messaging occurs before UE has reached a point of degradation of the WLAN signal sufficient for UE 105 to decide to switch connection on its own (because when that point is reached, UE 105 has failed multiple packets, retried them multiple times, rate shifted down multiple times, before eventually giving up on WLAN, causing a loss delay of perhaps 8 to 12 seconds). An example of this would be an 802.11 v message sent from AP 127 to UE 105, telling it to initiate the roam. 802.11 v messages are commonly a WLAN to encourage a station to roam from one AP to another. In this embodiment, these messages are instead used to ask a 5G-capable WLAN station, i.e., UE 105, to roam not to another Wi-Fi AP, but to 5G gNB 110.
10. UE 105 thereafter switches part of its data path to 5G. As the WLAN link continues to degrade, UE 105 switches more of its traffic to 5G until all traffic is on 5G.
11. UE 105 reaches WLAN domain boundary 212, and AP 127 signals to UE 105 using the same methods as above. UE 105 thereafter detaches from AP 127 (and has all of its traffic on the 5G link).
12. On the transition back to WLAN 120, operation 2 below is executed to ensure seamless moving (by using a single IP address) for future transitions.

### 5G to WLAN Transition

1. UE 105 initiates a 5G session (in this scenario it is assumed that WLAN communication is not available outside of building 280, and thus all traffic initially flows through the 5G link).
2. Initially, UE 105 keeps scanning for WLAN service and, upon detecting WLAN 120, associates and initiates connection to maintain a single IP through AMF 152 (at this point UE 105 has a single IP address for the 5G and WLAN link, that it will keep as it transitions from WLAN to 5G as described above). At the association point (to WLAN 120), UE 105 signals to gNB 110 and to AP 127. This information will be used in later iterations for gNB 110 to signal to 105 (and other UEs) where WLAN service is expected to become available. Thus, in next walks outside-in, gNB 110 signals to UE 105 when WLAN service should be available (removing the need for UE 105 to scan frequently).
3. As the WLAN link becomes usable for the UE traffic (in terms of bandwidth, delay, jitter), UE 105 requests traffic scheduling from AP 127 (e.g., FastLane+, SCS, etc.). UE 105 may request the scheduling of all its traffic (currently on the 5G link), or only part of it. Determination of such point can be made by UE's 105 own measurements or through signaling from AP 127.
4. As UE 105 keeps entering deeper into the WLAN domain and the 5G connection becomes weaker, UE 105 switches its 5G traffic flows to grant-free, and starts exchanging more traffic through the WLAN link (updating its scheduling request progressively and accordingly).
5. As the 5G link becomes marginal, UE 105 signals to gNB 110 and AP 127. UE 105 signals both to AP 127 and to gNB 110 that it wishes to roam from 5G to the WLAN's AP 127. UE 105 first becomes aware of the (preferred) AP 127 first through a better Received Signal Strength Indicator (RSSI) value compared to a nearby AP. It associates, but does not yet use this to send traffic. When UE 105 determines that a roam is likely necessary and is possible, it signals to AMF 152 that it will discontinue the session. At this time, UE 105 no longer transmits over the 5G interface, and begins transmitting over WLAN 120 to AP 127.
6. Eventually, UE 105 loses 5G and is entirely supported by WLAN 120.

Thus, those skilled in the art will appreciate that both domains (5G/WLAN 120) are expected to partially overlap: a traversal from 5G to WLAN 120 would start within 5G usability boundary 221, UE 105 would then reach the WLAN domain boundary 212 (where it can join WLAN 120), then reach the WLAN usability boundary 211 (where WLAN 120 reception is good) then the 5G domain boundary 22 (where 5G drops). In the other direction, UE 105 would start within WLAN usability boundary 211, reach 5G domain boundary 222 (where it is possible to join 5G), then reach the 5G usability boundary 221 (to thus send more or all traffic over 5G), then reach WLAN domain boundary 212 (where WLAN 120 reception drops). With this approach, UE 105 can determine when to activate one link or the other, and when to switch some then all of its traffic to the other link (before the first link becomes completely unusable).

It is noted that UE 105 is not expecting to be instructed to roam from WLAN 120 to 5G or back. UE 105 is not instructed to report on RF conditions. UE 105 is not configured by an external entity to roam. Rather, UE 105 signals to WLAN 120 AP 127/gNB 110 the points at which it (UE 105) reaches critical signal levels, but the goal is to use those points, during subsequent “walks” as flags for the next traversal. At the same points, AP 127 will signal back, informing UE 105 that this (RF) location is the place where a key point was reached. This approach of virtual RF markers allows UE 105, on its next traversal to more quickly find the points or locations where the next technology will become available. These messages are flags, not reports as described in TS 36.331. Their only resemblance is that both are messages from UE 105 to the infrastructure about RF signals. But their goal and content are unrelated.

In an embodiment, a cell boundary is agreed upon through communication between the WLC 125 controller and the packet core. UE 105 is capable of “seeing” both, along with the relative RSSI values. WLC 125 and 5G packet core agree on an RSSI/SNR threshold between themselves where a UE roams between the systems. Notably, the boundary is really only relative from the UE's 105 point of view, and this can easily be reported back to the WLC 125 and thus fast transfer logic 250 and the packet core. As such, WLC 125 and the packet core now communicate and agree on a roaming boundary for UE 105.

As further explanation, consider the case of WLAN 120, where UE 105 has the roaming initiative. UE 105 would move away from AP 127, reach a point where its algorithm concludes that the current connection is not sustainable much longer (because of signal thresholds, losses, data rate shifts etc.) and would then start scanning for an alternate WLAN connection. Finding a better WLAN connection point, it would terminate its previous connection, switch channel, then attach to a new AP. In the scenario of the present disclosure, namely exiting building 280, UE 105 would scan, fail to identify a better WLAN connection point, then end up dropping its connection after several cycles of scanning/attempting to continue exchanging though the current AP.

In contrast, and has been explained herein, UE 105 reaches a point that is identified as a cell boundary, the infrastructure signals that that is the case. In response to such signaling, UE 105 starts attempting to switch traffic to the 5G link before reaching the point of failure. Additionally, WLC 125 (i.e., fast transfer logic 250) and packet core are in agreement that the roam is going to happen and prepares for it. Depending on the size of overlap region 270, UE 105 may immediately be successful, or may need to partially continue over the WLAN link. In both cases, the method described herein allows the UE to switch its traffic early, thus limiting the risks of degradation.

The embodiments described herein recognize a distinction between a “first walk” (where no other UE has traveled that path/first deployment) from subsequent walks. In a first walk. UE 105 would not receive the assistance from AP 127 (fast transfer logic 250) to discover the point where 5G becomes available. UE 105, during a first walk, discovers this point on its own with standard method. However, UE 105 receives assistance from AP 127 to discover that it is at the boundary of the WLAN domain (and not just at the boundary of one of the WLAN cells, with more WLAN cells available as UE 105 continues its path). However, on its return path, UE 105 will signal to AP 127 the point where the 5G signal becomes marginal (then unusable). As such, AP 127 knows from there-on at what WLAN signal level UE 105 is expected to start benefiting from a 5G signal (the same logic is applied in reverse for the 5G to WLAN boundary point), and will thus be able to assist UE 105 in subsequent WLAN 120 to 5G walks, i.e., transitions.

However, UE 105 need not switch its traffic to 5G just because it reaches a point where the 5G network is available, assuming the WLAN 120 signal is still usable. This is why the methodology described herein allows UE 105 to gain knowledge of this availability, then to continue sending traffic to the WLAN link for a while, while it establishes a link to the 5G side (but does not use the 5G link for most of its traffic). Then, UE 105 progressively switches its flows (based on their sensitivity to retries etc.) to 5G as the WLAN link degrades. The main goal here is to have UE 105 connect to the other link technology (5G in the WLAN to 5G direction) before its primary link becomes unusable, thus progressively switching its traffic to the next technology.

In essence, when UE 105 moves from 5G to WLAN domains, then reaches a point where the 5G signal becomes marginal, UE 105 signals AP 127. AP 127 records the WLAN conditions (e.g., RSSI/SNR) from UE 105 at that point. Accordingly, AP 127 (and fast transfer logic 250) knows, when UE 105 moves in the other direction, at what point it should signal to UE 105 that the 5G link should be available to try (the same logic happens in reverse for the WLAN 120 to 5G transition). As this information is sent at each movement 5G to WLAN, AP 127/WLC 125/fast transfer logic 250 keeps being updated about the boundary position by each inward movement.

With a grant free uplink access, UE 105 can progressively switch its UL traffic toward the 5G link without requesting permission from gNB 110. This allows UE 105 to dynamically redirect more or less traffic to the 5G link as it reaches WLAN domain boundary 212. Thus, UE 105 can arbitrate the best link for each next UL packet in real time. However, UE 105 could also proceed without the grant free, and request the UL for each flow from gNB 110. The method would still be functional, albeit less reactive to the real-time WLAN 120 conditions.

Reaching the cell boundary is typically a stochastic event. A frame is successfully sent at a given data rate to AP 127, then the next frame at the same data rate fails (causing UE 105 to retry, and often be successful on the first, or subsequent retry). At some point, too many retries cause UE 105 to decide to rate-shift down instead, resulting in a lower throughput but better success rate. The same process occurs again until UE 105 decides that the failures and rate shifts are too many/too close to each other for the link to be deemed usable. The methodology described herein suppresses this failure slope. In accordance with the disclosed embodiments, UE 105 can send a frame, observe that it was not acknowledged and (instead of undergoing the 802.11 procedure to retry n times, rate shift, retry again etc.) decide to shift this packet to the 5G link while it attempts to send the next packet over WLAN 120. With this type of procedure, UE 105 can optimize the count of its retries on the WLAN link and the amount of the rate shifts. In a normal scenario, UE 105 will have different types of traffics to send, some that may be more sensitive to delay and jitter, and will likely arbitrate to switch these flows to the 5G link as early as the first retry, while it may wait for an HTTP GET transaction to complete, for example, before switching less jitter/delay sensitive traffic. Thus, the sensitivity of traffic may dictate the switch speed. In many cases, the DSCP label is a good indicator of a flow sensitivity to delays and retries. It is also noted that many operating systems implement, in their socket calls, a timer that indicates success or a need to consider a packet retransmission (or drop).

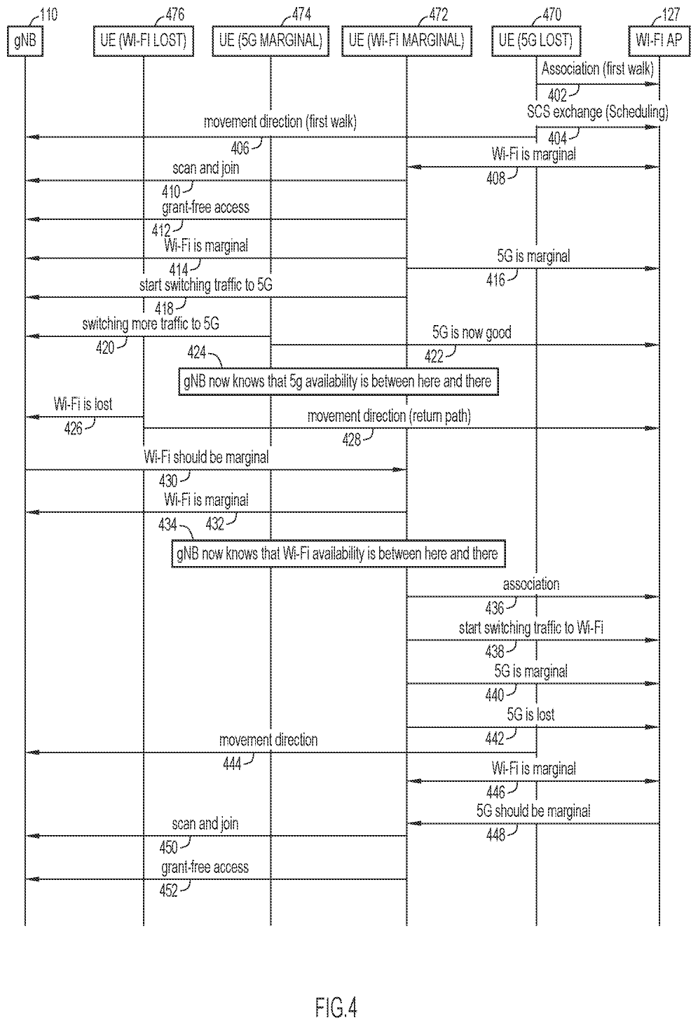

FIG. 4 shows a series of operations for effecting fast transfer between WLAN operations and 5G network operations, according to an example embodiment.

FIG. 4 shows gNB 110 and AP 127 along with indications of where UE 105 might be located at a given time. For instance, at 470, UE 105 is at a location where 5G service is lost. At 472, UE 105 is at a location where Wi-Fi service is marginal. It is noted that FIG. 4 uses the terminology “Wi-Fi” for WLAN 120, but those skilled in the art will appreciate that the different terminology is interchangeable. At 474, UE 105 is at a location where 5G service is marginal. And, at 476, UE 105 is at a location where Wi-Fi service is lost.

As shown in the figure, at 402, UE 105 performs a “first walk” towards AP 127. UE 105 will associate itself with WLAN 120 associated with AP 127, i.e., Wi-Fi service. Thereafter, at 404, UE 105 will conduct an SCS exchange and scheduling with AP 127. At 406, UE 105 may move in a direction towards gNB 110, i.e., towards 5G service.

At 408, FIG. 4 4 indicates that Wi-Fi service is marginal. At 410, UE 105 scans and joins the 5G network via gNB 110. At 412, grant-free access is provided to UE 105. As indicated at 414, Wi-Fi service is marginal between gNB 110. At the same time, at 416, 5G service is indicated as being marginal towards AP 127.

At 418, traffic begins to switch from Wi-Fi service to 5G service. At 420, even more traffic is switched from Wi-Fi service to 5G service. At 422, it is indicated that 5G service is now “good,” meaning that gNB 110 knows, as indicated at 424, that 5G is available between locations 474 and 470. This information may be supplied to domain boundary definitions database 310 (FIG. 3).

At 426, Wi-Fi service is completely lost. At that point, at 428, UE 105 begins movement in a direction towards AP 127 and Wi-Fi service provided thereby. During this time, as indicated at 430, Wi-Fi service should be marginal. This is similarly shown at 432, wherein UE 105 is moving in the opposite direction towards gNB 110. At this point, gNB 110 knows, as indicated at 434, that Wi-Fi availability is available, at least, between locations 476 and 472.

At 436, UE 105 again associates with AP 127, but this time as a result, perhaps, of being signaled by gNB 110 (in conjunction with fast transfer logic 250) given knowledge of boundaries stored in domain boundary definitions database 310. At 438, traffic that was being handled by 5G service, now begins to switch to Wi-Fi service. During this time, at 440, 5G service is marginal and ultimately, at 442, 5G service is lost beyond location 470. Once again, at 444, UE 105 moves towards gNB 110. As shown, at 446, Wi-Fi service is marginal towards location 472, and at the same time, at 448, 5G service should also be marginal.

At 450, UE 105, upon being signaled by AP 127 (fast transfer logic 250) scans and joins 5G service supported by gNB 110, which provides grant-free access at 452.

Thus, as shown in FIG. 4, after a first walk from 5G service to Wi-Fi service (i.e., service from WLAN 120), and back, it is possible, in accordance with the embodiments described here in to signal to UE 105, when to begin scanning, and joining a radio network different from a radio network that UE 105 is currently using. This process enables UE 105 to reduce latency and communication disruptions that might normally happen if UE 105 would first have to lose connectivity to, e.g., Wi-Fi service, before trying to establish communication with a 5G network.

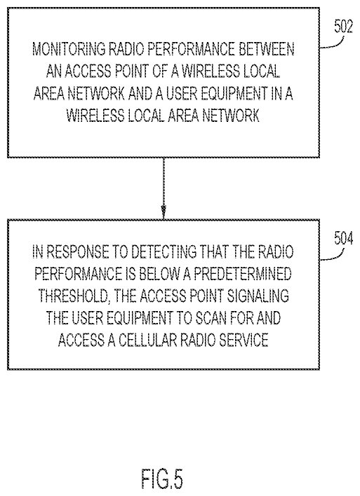

FIG. 5 shows another series of operations for executing fast transfer logic, according to an example embodiment. At 502, an operation includes monitoring radio performance between an access point of a wireless local area network and a user equipment in a wireless local area network. And, at 504, an operation includes in response to detecting that the radio performance is below a predetermined threshold, the access point signaling the user equipment to scan for and access a cellular radio service.

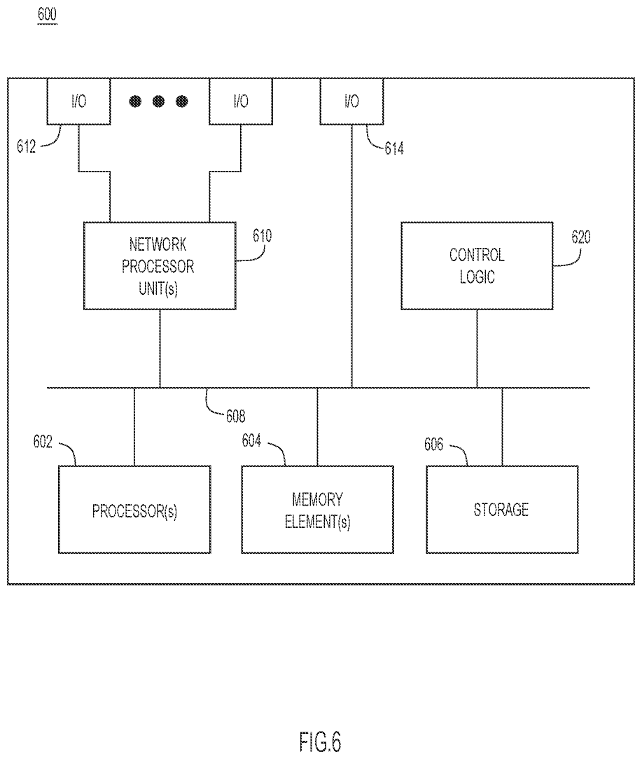

FIG. 6 is a block diagram of a computing device that may be configured to execute fast transfer logic 250 and perform the techniques described herein, according to an example embodiment. In various embodiments, a computing device, such as computing device 600 or any combination of computing devices 600, may be configured as any entity/entities as discussed for the techniques depicted in connection with FIGS. 1-5 in order to perform operations of the various techniques discussed herein.

In at least one embodiment, the computing device 600 may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620 (which could include, for example, fast transfer logic 250. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa) or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computing device 600. For example, I/O interface(s) 614 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a method may include monitoring radio performance between an access point of a wireless local area network and a user equipment in a wireless local area network, and in response to detecting that the radio performance is below a predetermined threshold, the access point signaling the user equipment to scan for and access a cellular radio service.

The method may further include progressively moving traffic from the wireless local area network to the cellular radio service.

The method may further include moving all traffic from the wireless local area network to the cellular radio service prior to losing connectivity to the wireless local area network.

The method may further include progressively moving the traffic from the wireless local area network to the cellular radio service based on sensitivity of the traffic.

In the method, the radio performance may be represented as a Received Signal Strength Indicator (RSSI) value.

In the method, the cellular radio service may be a fifth generation (5G) cellular radio service.

In the method, a location at which the predetermined threshold is met may correspond to a wireless local area network usability boundary, beyond which bandwidth of a channel of the wireless local area network decreases.

The method may further include requesting grant-free access to the cellular radio service.

In the method, the cellular radio service and wireless local area network may be operated by a same (private) enterprise.

In the method, a same Internet Protocol address may be used for communicating traffic over each of the wireless local area network and the cellular radio service.

In another embodiment, a device may be provided and may include an interface configured to enable network communications, a memory, and one or more processors coupled to the interface and the memory, and configured to: monitor radio performance between an access point of a wireless local area network and a user equipment in a wireless local area network, and in response to detecting that the radio performance is below a predetermined threshold, cause signaling, by the access point, the user equipment to scan for and access a cellular radio service.

In the device, the one or more processors may be further configured to cause the user equipment to progressively move traffic from the wireless local area network to the cellular radio service.

In the device, the one or more processors may be further configured to cause the user equipment to move all traffic from the wireless local area network to the cellular radio service prior to losing connectivity to the wireless local area network.

In the device, the one or more processors may be further configured to cause the user equipment to progressively move traffic from the wireless local area network to the cellular radio service based on sensitivity of the traffic.

In the device, the radio performance may be represented as a Received Signal Strength Indicator (RSSI).

In the device, the cellular radio service may be a fifth generation (5G) cellular radio service.

In the device, a location at which the predetermined threshold is met may correspond to a wireless local area network usability boundary, beyond which bandwidth of a channel of the wireless local area network decreases.

In yet another embodiment, one or more non-transitory computer readable storage media encoded with instructions are provided and that, when executed by a processor, cause the processor to: monitor radio performance between an access point of a wireless local area network and a user equipment in a wireless local area network, and in response to detecting that the radio performance is below a predetermined threshold, cause signaling, by the access point, the user equipment to scan for and access a cellular radio service.

In an embodiment, the instructions, when executed by the processor, may be configured to cause the user equipment to progressively move traffic from the wireless local area network to the cellular radio service.

In an embodiment, the instructions, when executed by the processor, may be configured to cause the user equipment to move all traffic from the wireless local area network to the cellular radio service prior to losing connectivity to the wireless local area network.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
monitoring radio performance between an access point of a wireless local area network and a user equipment in a wireless local area network; and
in response to detecting that the radio performance is below a predetermined threshold, the access point signaling the user equipment to scan for and access a cellular radio service.

2. The method of claim 1, further comprising progressively moving traffic from the wireless local area network to the cellular radio service.

3. The method of claim 2, further comprising moving all traffic from the wireless local area network to the cellular radio service prior to losing connectivity to the wireless local area network.

4. The method of claim 2, further comprising progressively moving the traffic from the wireless local area network to the cellular radio service based on sensitivity of the traffic.

5. The method of claim 1, wherein the radio performance is a Received Signal Strength Indicator (RSSI).

6. The method of claim 1, wherein the cellular radio service is a fifth generation (5G) cellular radio service.

7. The method of claim 1, wherein a location at which the predetermined threshold is met corresponds to a wireless local area network usability boundary, beyond which bandwidth of a channel of the wireless local area network decreases.

8. The method of claim 1, further comprising requesting grant-free access to the cellular radio service.

9. The method of claim 1, wherein the cellular radio service and wireless local area network are operated by a same enterprise.

10. The method of claim 1, wherein a same Internet Protocol address is used for communicating traffic over each of the wireless local area network and the cellular radio service.

11. A device comprising:
an interface configured to enable network communications;
a memory; and
one or more processors coupled to the interface and the memory, and configured to:
monitor radio performance between an access point of a wireless local area network and a user equipment in a wireless local area network; and
in response to detecting that the radio performance is below a predetermined threshold, cause signaling, by the access point, the user equipment to scan for and access a cellular radio service.

12. The device of claim 11, wherein the one or more processors are further configured to cause the user equipment to progressively move traffic from the wireless local area network to the cellular radio service.

13. The device of claim 12, wherein the one or more processors are further configured to cause the user equipment to move all traffic from the wireless local area network to the cellular radio service prior to losing connectivity to the wireless local area network.

14. The device of claim 12, wherein the one or more processors are further configured to cause the user equipment to progressively move traffic from the wireless local area network to the cellular radio service based on sensitivity of the traffic.

15. The device of claim 11, wherein the radio performance is a Received Signal Strength Indicator (RSSI).

16. The device of claim 11, wherein the cellular radio service is a fifth generation (5G) cellular radio service.

17. The device of claim 11, wherein a location at which the predetermined threshold is met corresponds to a wireless local area network usability boundary, beyond which bandwidth of a channel of the wireless local area network decreases.

18. One or more non-transitory computer readable storage media encoded with instructions that, when executed by a processor, cause the processor to:
monitor radio performance between an access point of a wireless local area network and a user equipment in a wireless local area network; and
in response to detecting that the radio performance is below a predetermined threshold, cause signaling, by the access point, the user equipment to scan for and access a cellular radio service.

19. The one or more non-transitory computer readable storage media of claim 18, wherein the instructions, when executed by the processor, are configured to cause the user equipment to progressively move traffic from the wireless local area network to the cellular radio service.

20. The one or more non-transitory computer readable storage media of claim 18, wherein the instructions, when executed by the processor, are configured to cause the user equipment to move all traffic from the wireless local area network to the cellular radio service prior to losing connectivity to the wireless local area network.
